(19) United States
(12) Patent Application Publication
(10) Pub. No.: US 2012/0201470 A1
(43) Pub. Date: Aug. 9, 2012

(54) RECOGNITION OF OBJECTS

(76) Inventors: Martin Pekar, Mlada Boleslav (CZ); Martin Caslava, Kolin (CZ); Pavel Doskar, Mlada Bolelav (CZ); Jakub Honc, Ceske Budejovice (CZ)

(21) Appl. No.: 13/052,510

(22) Filed: Mar. 21, 2011

(30) Foreign Application Priority Data
Feb. 3, 2011 (DE) 10 2011 010 315.5

(51) Int. Cl. G06K 9/46

(52) U.S. Cl. 382/203

(57) ABSTRACT

Pre-defined objects in a digital image are recognized in a real-time automated fashion by using computer resources for detecting contours within the digital image and comparing the detected contours to properties describing predefined objects taking into account a classification of the objects.

The invention relates to a method for real-time automatic recognition of objects within a digital image or a sequence of images (video). The invention also relates to a mobile terminal device.

The extent of networking increases with the advance of globalization. Nowadays it is not only important to be available anywhere and at any time, but also that the mobile terminal device used for this purpose is equipped with a number of features that go beyond the usual ability to make phone calls.

Nowadays, it is also almost taken for granted that a mobile terminal device, such as a smart phone or laptop, is permanently connected to the Internet to synchronize its data. Furthermore, nowadays it's almost standard that such mobile terminal devices are equipped with a camera and video capabilities in order to take photos or to capture videos which then can be provided to other programs for further processing.

One example is a piece of software for a smart-phone which can be used to decrypt a digital bar code within a digital image. For this purpose a digital image is taken with the digital camera function of the smart-phone. Then the digital image is made available to the software which in turn determines and analyzes the bar code contained in the digital image. Then the result can be shown on the—usually fairly large—display of the smart phone.

Another example of the high integration of mobile terminal devices in everyday life is the so-called “Augmented Reality”. In Augmented Reality a mobile terminal device, such as a smart phone, is used to take a photo of the surrounding environment of the user, for example a landmark of a large city. Thereafter, the digital image is analyzed, whereby the software determines which object there is within the image so that more information can be displayed to the user. Thus, with this functionality the long route via the Internet by entering keywords and finding the relevant results is abbreviated.

However, one problem with this type of functionality is the low processing power of mobile terminal devices. In order to meet the desire of users for independence many manufacturers of mobile terminal devices use components which are optimized in terms of power consumption to ensure the longest possible battery life. However, this does limit generally the performance of such a mobile terminal device so that real-time image processing and recognition is not possible without further ado.

### Task

In view of this, the task of the invention at hand is to provide a method by which objects within a digital photograph or a sequence of images (video) can be recognized automatically in real time.

### Solution

The problem is solved with the aforementioned method for real-time automatic recognition of objects within a digital image stored in a computer, utilizing a multitude of individual color points, and consisting of the following steps:
Detecting of contours contained in a digital image by computing resources provided by the computer, and
Identifying of at least one object by computing resources in response to a comparison of the detected contours from a digital image by utilization of the properties describing the objects taking into account a classification of the objects based on the properties of the objects.

Initially, according to the invention, there is the determination of the significant contours within the digital image. For example, such a contour recognition can be realized with gradients of two adjacent pixels.

Contours are characterized in general by the fact that they emerge from their surroundings, which can be determined within a gray scale image using the gray scale curve toward or away from the contour.

It is particularly beneficial for this purpose if a digital color image is first converted to a gray scale image and then emphasized with the corresponding contours by means of suitable algorithms to enhance detection of the contours. The emphasizing of contours can occur, for example, by darkening all image points which are above a certain gray threshold while all image points which are below the gray threshold are calculated brighter so that the contours stand out more clearly from the environment. With a suitable algorithm such as the so-called “Canny algorithm” the contours contained in the digital image can be determined.

In the next step, the previously determined contours are recognized with object descriptions of objects to be recognized, taking into account a classification of these objects. The object descriptions include the description of the object properties, starting with the contours of the objects to be recognized up to the gray scale thresholds, aspect ratios, shifts within the image and the like. Utilizing a previous classification of objects, whether it be a single object, a nested object, an object sequence or a word, the determined contours are compared to the object descriptions so that without much computing time, one or more objects within a digital image can be recognized quickly, i.e. in real-time.

To improve the recognition rate and to avoid respective error codes it is particularly advantageous to validate the recognized objects within the digital image, i.e. does the recognized object match with the object to be recognized. Such validation can take place beneficially in dependence of the aspect ratios of the recognized objects in the digital image and can be compared with the looked-for original object. If the aspect ratios do not match, one can conclude, that it is not the recognized object. Another form of validation is possible with color comparison between the recognized object within the digital image and the original object. Such color comparison can possibly be performed quickly and efficiently using a so-called histogram, whereby the histogram includes the statistical distribution of the containing colors.

In order to also recognize words within the captured digital image it is particularly beneficial to expand the recognized contours, i.e. to widen the width of the contour.

Individual letters of the word are merged into each other in a way so that they no longer can be recognized individually. Thus, a word is depicted in its entire outer contour. Then, an object classified as a word is recognized as a result of these extended contours, whereby primarily the outer contour serves as a description of the object to be recognized. Individual letters of the word do not need to be identified as this would result in slower performance. Thus, the words are identified by their external outline as a whole.

Furthermore, it is particularly beneficial when objects are identified by a sequence of objects such as those found in controls, for example, in a car. Such objects, classified as sequential, still receive as object description the parameters on how many adjacent contours there are and their form or properties. Therefore the object will be recognized as the object to be identified when the defined number of adjacent contours can be recognized at the position of the recognized object. Thus, specific controls within a series of nearly identical-looking controls can be automatically recognized without much computing time.

Furthermore, it is particularly beneficial when objects that were classified as nested, are recognized depending on a primary contour. After the primary contour has been recognized, the object can be, for example, recognized in dependence of a relative position of the object to be recognized to the primary contour by searching for an object to be recognized within an ROI (region of interest). This is particularly beneficial when the primary contour is relatively easy to recognize and when all other objects can be recognized based on their relative position within the ROI in regards to the primary contour. The object to be recognized and classified as nested can be within or partially outside the primary contour. It can also be entirely outside the primary contour.

Preferably, the computer with which the method is performed should be a mobile terminal device which is equipped with a position sensor to determine position information of the terminal device. If the mobile terminal device is rotated during the capturing or recording of an image or a video the captured image or recorded video will be corrected based on the respective position information of the terminal device to ensure further proper processing and recognition.

Moreover, the aforementioned task is solved also with a mobile communication device that is equipped with at least one CCD sensor to capture a digital image or image sequence and which is also equipped with the computing resources to perform the aforementioned method. Therefore, such a mobile communications device can be used, for example, to capture the dashboard of a motor vehicle, whereby a display, which is also connected to the mobile communication device, can show or highlight next to the captured image also the recognizable objects.

The invention is illustrated exemplary in the accompanying drawings. The following is depicted:

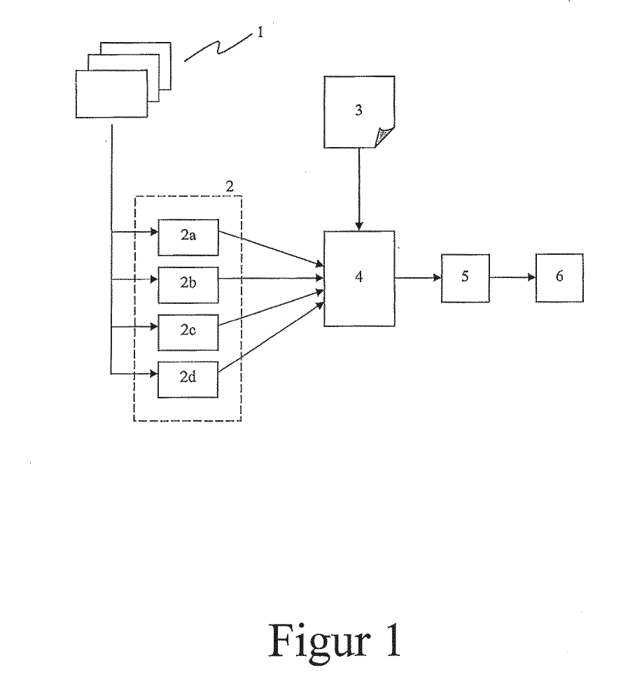

FIG. 1—schematic block diagram of the process flow;

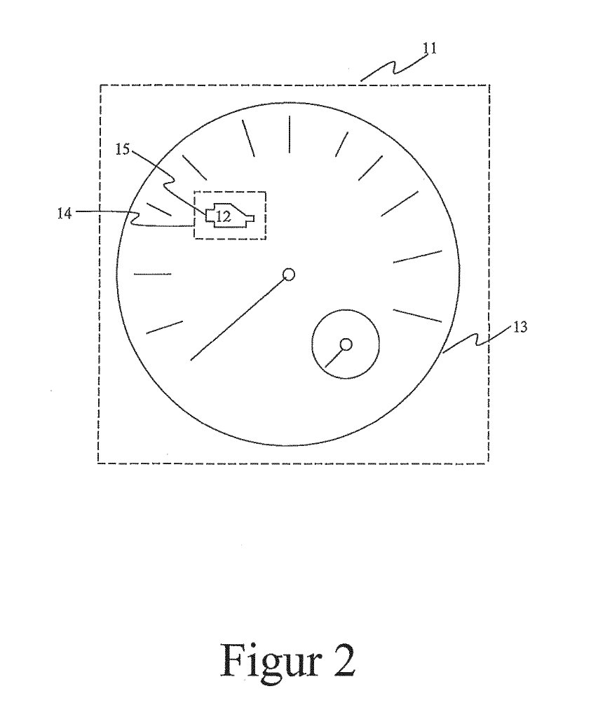

FIG. 2—contour recognition based on a dashboard;

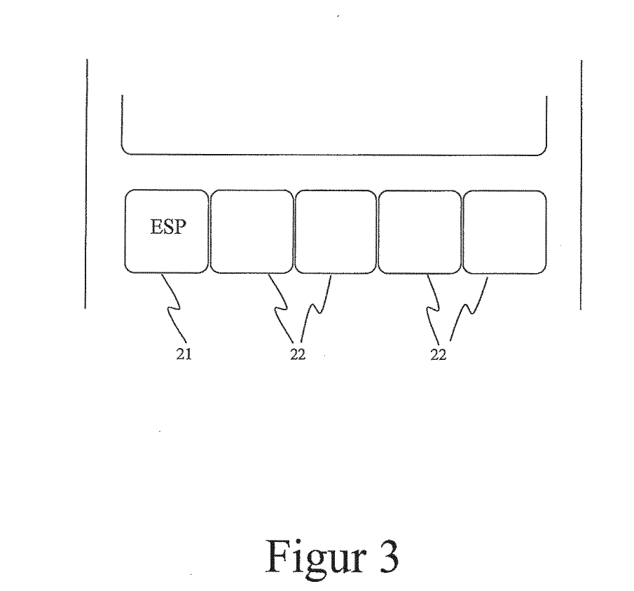

FIG. 3—sequential recognition of objects;

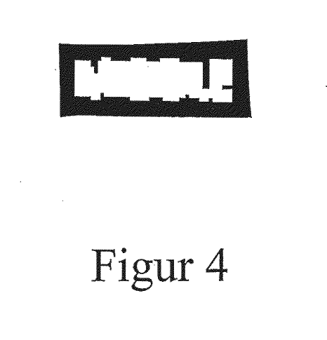

FIG. 4—recognition of words.

FIG. 1 shows schematically the process flow. Before start of the process a series of recognizable objects 1 are known which do have a respective description of their properties. In the simplest case this might be the template of the object to be recognized. It is also conceivable that the description contains a contour description of the outline, the absolute position, relative position with respect to other contours or the like in order to describe the object.

The objects to be recognized are classified in order to speed up the recognition. In this process example it is classification 2a which classifies a simple object contour; classification 2b which classifies a nested object as a function of another contour; classification 2c which classifies a sequential arrangement of the object to be recognized within a sequence of contours and classification 2d which classifies a word to be recognized.

The object descriptions 1 along with their classifications 2 are then used as the basis for object recognition. Of course, a captured digital image, in which the aforementioned objects 1 can be recognized, is required as another input parameter. In block 4 the actual recognition takes place. Initially all contours that are within image 3 are identified. In order to simplify the recognition of the contours image 3 is first converted to a grayscale image where each color has a corresponding gray value. Ideally, the corresponding contours still can be improved by increasing the gray values from a certain grayscale value while below this value they are reduced. Subsequently, the so emphasized contours can be recognized.

Thereafter the recognition of objects 1 take place in dependence of their corresponding description and by reference or regard to their classification, in order to be able to recognize objects in picture 3 as quickly and efficiently as possible.

After that a validation of the recognitions can follow optionally, by checking whether the recognized objects are correct or not in regards to certain plausibility. For example, the aspect ratio of the objects 1 to be recognized can be compared with the object of image 3, whereby one can conclude in case of a significant deviation that the recognition is incorrect. It is also conceivable that a color comparison is performed using a histogram. The validation takes place in block 5.

Subsequently, the captured image 3 can be shown on a display of a mobile communication device, whereby the corresponding object recognitions of objects 1 are graphically highlighted in image 3 so that a user can see the recognition. Then, the depiction is finally in block 6.

FIG. 2 shows an example of a depiction of a portion of a dashboard 11. The depiction shows an image taken from the dashboard after the contours were emphasized and recognized. Based on a simple example the object recognition of the object 12 will be described briefly. Object 12 is the well-known engine control light in a vehicle which usually lights up when there is a failure in the engine or exhaust system.

First, the outer contour 13 of the display element is recognized. Due to the classification of the object 12 as a nested object it is known in the property description at which relative position object 12, to be recognized, is located within contour 13. Thus if contour 13 has been recognized, a search for the respective object can be performed in area 14 (ROI). If the engine control light 12 lights up during the capturing of the image, it will also be recognized by the process within region 14. If it does not light up no recognition will be detected.

Thus, FIG. 2 is an example of a nested classification of the object 12. However, contour 13 is a simple object contour which is recognized by its description.

FIG. 3 shows an example of a sequential arrangement of recognizable objects. In the process sample of FIG. 3 the control panel element that says “ESP” within a vehicle is to be recognized. The problem here is that such control elements look usually identical and thus can not easily be distinguished.

The control element 21 which is to be recognized as an object is characterized by a square outline shape. Further, FIG. 3 shows schematically the result of the emphasizing of the contours. After object 21 has been recognized it is checked if there are other identical objects 22 next to object 21. If so, it can be concluded that it is the object 21 looked for.

In the sequential classification it can be recorded in the object description at what distance and how many identical objects there are next to the searched for object. Even then, it is a part of the object description.

FIG. 4 finally shows an example for a word classification and recognition of a word as a whole. In this process example a part of an integrated car radio was photographed which has controls that are labeled with the words “Bass”, “Middle”, “Treble”, “Balance and “Fader”. Now, the word “Middle” is looked for.

To prevent that the recognition is based on individual letters the contours within the picture are expanded or inflated so that the individual letters get merged with one another. An example of the expansion of the contours of the word “Middle” is shown in FIG. 4.

It can be seen that the word “Middle” can no longer be recognized easily. However, the outline or contour of this figure does have a unique characteristic, so that the word “Middle”, as a whole, can be recognized by this characteristic. Thus, a description of contours might be sufficient for simple words. It is also conceivable that a comparison is made with templates.

The application of such process or technique for rapid recognition of objects in digital images is manyfold. Examples include a mobile communications device which is equipped with a digital camera. Now, if a video is taken from the dashboard, the objects within it can be recognized in real-time so that they can be shown emphasized on the display.

This is particularly beneficial when information is stored along with each recognized object. If for example the engine control light lights up and this is detected by the communication device additional information can be displayed in regards to a possible failure of the vehicle if the user presses on the touchsensitive display at the point of emphasis.

1. A method for real-time automatic recognition of predefined objects within a digital image stored in a computer which includes a number of individual picture elements, comprising:
detecting contours contained in a digital image by computing resources provided by the computer, said detecting step yielding detected contours of one or more objects in said digital image, and
identifying at least one object by computing resources based on a comparison of the detected contours utilization of properties describing the one or more objects taking into account a classification of the one or more objects based on properties of the one or more objects.

2. The method of claim 1, further comprising the steps of transforming the digital image to a digital gray-scale image and highlighting of contours contained in the digital gray-scale image.

3. The method of claim 2 further comprising the step of validating detected objects in the digital image.

4. The method of claim 3, wherein said step of validating includes recognition in dependence of at least one of aspect ratios and color distribution of detected objects in the digital image with predetermined objects to be recognized.

5. The method of claim 1 further comprising the step of expanding of recognized contours in the digital image so that adjacent letters merge and recognition of an object classified as a word is made in dependence on of the expanded recognized contours.

6. The method of claim 5 wherein recognition of an object classified as sequential is made in dependence on adjacent contours of the object.

7. The method of claim 1 wherein recognition of an object classified as nested is made in dependence on recognition of a primary contour.

8. The method of claim 1 further comprising the step of correcting the digital image in dependence on location information of a recorded unit, and position sensors for determination of said location information during shooting of the digital image.

9. Mobile communication device with at least one CCD sensor to capture a digital image (3) or a sequence of images (video) and computing means for performing the aforementioned method using a digital image (3) re-corded by the CCD.

10. Mobile terminal device based on claim 9, characterized by a communication device with a display, set up to display a digital image and the detected objects within the digital image.
